(19) United States
(12) Patent Application Publication
(10) Pub. No.: US 2009/0215461 A1
(43) Pub. Date: Aug. 27, 2009

(54) SYSTEM AND METHOD FOR DATA COMMUNICATION THROUGH CALL SEPARATION AND CONTROL BY MOBILE SWITCHING CENTER

(76) Inventor: Yong Jin Kim, Seoul (KR)

Correspondence Address: MORGAN & FINNEGAN Transition Team;C/O Locke Lord Bissell & Liddell, 3 WORLD FINANCIAL CENTER, NEW YORK, NY, 10281-2101, US

(21) Appl. No.: 11/917,274

(22) PCT Filed: Jun. 27, 2006
(86) PCT No.: PCT/KR2006/002477

§ 371 Date: Jun. 9, 2008

(30) Foreign Application Priority Data
Jun. 28, 2005 (KR) 10-2005-0056362
Jan. 4, 2006 (KR) 10-2006-0001017

(51) Int. Cl. H04W 40/00

(52) U.S. Cl. 455/445

(57) ABSTRACT

The present invention which relates to a data communication system and method of performing a data service according to a request of a calling party provides processing a data call by subdividing the voice call processing scheme of a mobile switching center depending on whether or not the called party is registered and by inducing a call to be connected to (as) a data call prior to upon processing a voice call. In other words, when a call is originated from any calling party, if a called party is registered with the CPDS as its user, the mobile switching center processes the call as a data call and transmits the information and contents registered by the called party to induce a data communication, and if the called party is not registered with the CPDS as its user, the mobile switching center processes the call as a voice call to induce a speech call. Another embodiment of the present invention enhances the convenience of the calling party by inducing a call to be connected to a data call prior to voice call processing, through a method in which the voice call processing scheme of a mobile switching center is subdivided according to whether or not the calling party is registered with the CPDS and an application program (application) stored in the calling party's terminal is executed. In other words, when a call is originated from a calling party, if he or she is registered with the data service, then the mobile switching center executes an application which is already stored in his or her terminal at the time of registration of service being effected to have the calling party select and utilize the information and contents that are registered by the called party on the application screen of the calling party's terminal, or request a speech call.

### TECHNICAL FIELD

The present invention relates to a data communication system and method in which the voice call processing scheme of a mobile switching center is subdivided on the basis of whether or not the calling/called party is registered to induce a call to be connected to a data call prior to processing a voice call so that the data service is performed according to a request of the calling party when a data call is processed.

### BACKGROUND ART

The functions of a hand-held mobile terminal (hereinafter referred to as “Wireless terminal”) and the technique of data communication has been rapidly developed as the supply of the wireless terminal is extended. Currently, a video (conference) communication between the wireless terminals has become possible and various types of data services are being commercialized.

However, the degree of use of data service lags behind functions of the wireless terminal and the development of the mobile communication technique due to the limited supplying path and the shortage of contents that make the most of the features of data communication. Data service being used nowadays is done restrictively at the contents portal site which is operated by the owner of the mobile communication, and thus the activation of data communication has been delayed due to the features of contents in which users of such contents portal sites are limited. Further, images or music services that are provided by a called party are additional services, during waiting for communication, which are generated for a few seconds before the call path is completed by the response of the called party. It is difficult to regard the service as a service that makes the most of the features of data communication and it does not contribute to the activation of the data communication.

### DISCLOSURE OF INVENTION

### Technical Problem

The present invention has been made in view of the problems described above and according to the present invention, a data service is performed according to a request of the calling party (i.e., a originating party of a call) when processing a data call by subdividing the voice call processing scheme of a mobile switching center on the basis of whether or not the calling party or the called party (i.e., a terminating party of a call) is registered to induce call to be connected to a data call prior to processing a voice call.

Through such a data service system, all of the mobile communication subscribers are able to serve as a CP (Contents Provider) which configures his or her contents through such data service system and provides any of the calling party with the contents, and any of the calling parties use data services provided by a called party of their interests, whereby all of the telephone communication for a speech call is transmitted to the data call connections.

### Technical Solution

In order to accomplish the object described above, there is provided a data communication system in which a data service is performed according to a request of the calling party when processing a data call by subdividing the voice call processing scheme of a mobile switching center on the basis of whether or not the calling/called party is registered to induce a call to be connected to a data call prior to processing a voice call, the data communication system comprises:

a call separation and control means of the mobile switching center to terminate the connection of a voice call which is intended for a speech call by confirming that he or she has been registered with the CPDS when a call is originated and changing the voice call to a data call when the called party has produced his/her information and contents, and registered them with the CPDS (Contents Provider Data Service);

a first data service transmission control means of a CPDS server for receiving the information of the calling and called parties who are subscribed to the CPDS from the mobile switching center when the originating call is processed as a data call and transmitting the initial registration menu of the corresponding called party to the wireless terminal of the calling party, wherein the initial registration menu is classified according to each type of the calling party (e.g., family/school/company/fiance/friend/religion, etc.);

data service control means for performing data communication by confirming whether or not the calling party is one who desires to use data communication when the calling party retrieves the initial menu output to his or her terminal and selects any of the menus and requests the contents corresponding to the selected menu;

a second data service transmission control means of the CPDS server for transmitting to wireless terminal the contents that corresponds to the menu indicated (selected) by the calling party when the calling party requests a data service;

voice call reprocess means enabling a voice call by terminating the CPDS screen of the called party, simultaneously releasing the data call, and reinitiating the initial call to process it as a voice call, when the calling party requests a voice call after inspecting or downloading the contents of the called party through the data communication.

### BRIEF DESCRIPTION OF THE DRAWINGS

FIG. 1 illustrates an example of connections between the communication network and the CPDS providing system according to the present invention.

FIG. 2 illustrates a detailed configuration of the CPDS providing system according to the present invention.

FIG. 3 illustrates a flow chart showing the general service flow on which the calling subscriber uses the CPDS according to the present invention.

FIG. 4 illustrates a flow chart showing the service flow on which the calling subscriber uses the CPDS in the aspect of the call processing of the mobile switching center according to the present invention.

FIG. 5 illustrates a configuration of the CPDS subscriber contents database of FIG. 2 in conjunction with the procedure of data transmission.

FIG. 6 illustrates an embodiment of the method in which the CPDS screen and contents are registered or changed by the called subscriber according to the present invention.

FIG. 7 illustrates an embodiment of a service flowchart on which a calling party uses the CPDS service registered by a called (terminating) subscriber according to the present invention.

FIG. 8 illustrates another embodiment of a service flowchart on which a calling party uses the CPDS service of a called (terminating) subscriber according to the present invention.

FIGS. 9 and 10 illustrate an embodiment of a service flowchart on which the calling party uses the CPDS service of a called (terminating) subscriber using the Call Page Application according to the present invention.

FIG. 11 shows a service flowchart explaining the service flowchart shown in FIGS. 9 and 10 in the aspect of the calling party's subscription and utilization of the CPDS service.

### BEST MODE FOR CARRYING OUT THE INVENTION

Hereinafter, the preferred embodiment of the present invention will be explained in detail with reference to the accompanying drawings.

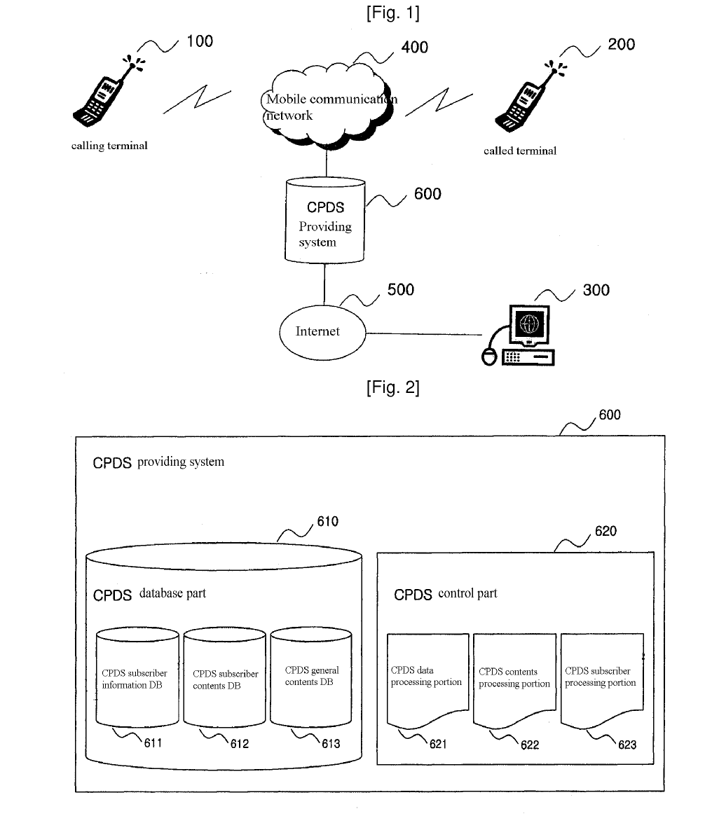

FIG. 1 shows examples of connections between the communication network and the CPDS providing system according to the present invention.

The CPDS providing system (600) is connected to the calling party's wireless terminal (100) for providing the CPDS via the mobile communication network (400), and connected to the called party's wireless terminal (200) via the mobile communication network (400) or to a PC (300) via Internet (500) for registering the CPDS initial menu and contents.

Preferably, both the calling and called party's wireless terminals (100 and 200) include (contain) the function that allows for registration/use of the CPDS initial menu and contents. However, even though the called party terminal is a conventional wired telephone, the called party terminal is also able to utilize the service of the present invention as in the wireless terminal by registering/changing the initial menu and contents using a PC (300) via Internet (500).

The CPDS providing system (600) is connected to the wireless terminal (200) via the mobile communication network (400) and according to the request of the wireless terminal (200), provides the functions capable of producing/registering/storing the CPDS initial menu and contents. The user of the CPDS is able to select the various contents protected by license that are provided by the CPDS providing system (600) and register the selected contents as his or her CPDS contents. Further, the user of the CPDS is also able to produce and register it as his or her CPDS initial menu and contents after selecting such data as suspended image, motion picture, text etc. and transmits it to the CPDS providing system. Furthermore, the user is able to produce and register his or her CPDS initial menu and contents using various images, motion pictures, data contained in a PC or various contents provided by the CPDS providing system (600) after accessing the CPDS providing system (600) using a PC (300) via Internet (500).

The registered CPDS initial menu and contents are provided to the calling party via the calling party's terminal (100) connected to the CPDS providing system (600).

FIG. 2 shows a detailed configuration of the CPDS providing system (600) according to the present invention.

The CPDS providing system (600) comprises the CPDS database part (610) including the CPDS subscriber information database (611), the CPDS subscriber contents database (612), and the CPDS general contents database (613), and the CPDS control part (620) including the CPDS data processing part (621) and the CPDS contents processing part (622) and the CPDS subscriber processing part (623).

The CPDS subscriber information database (611) is a database which contains information on subscribers who are registered with the CPDS, and serves to query/register/change/delete the information of corresponding subscribers in accordance with the request of the CPDS control part. The CPDS subscriber contents database (612) is a database in which the registered CPDS initial menu and contents information are contained in accordance with the request of the subscriber; the CPDS subscriber contents database (612) serves to query/register/change/delete the CPDS initial menu and contents of the called (terminating) subscriber in accordance with the request of the CPDS control part (620) and serves to query which CPDS initial menu and contents of the called subscriber are suitable for types of the calling party (e.g., family/school/company/fiance/friend/religion, etc.) in accordance with the CPDS control part (620), and transmit the selected information to the CPDS data processing part (621) when the calling party accesses the CPDS providing system (600) with an attempt to originate a call. The CPDS general contents database (613) is a database in which various contents protected by license such as various screens, motion pictures, music, characters, logos and data are available for the subscribers are contained, and serves to provide the data required for configuring the initial menu and contents of the corresponding subscriber in accordance with the request of the CPDS control part (620).

The CPDS data processing part (621) is designed for the calling and called party's wireless terminals (100 and 200) accessing the CPDS providing system (600) and is for transmitting and receiving the initial menu and contents data of the CPDS subscriber, and serves to receive and transmit data for registering/changing the initial menu and contents of the CPDS subscriber and for providing them. In other words, it receives the data such as the initial menu and image, motion pictures, items from the called party (200) etc. which are connected to the CPDS providing system (600) to register and change the CPDS initial menu and contents and store the data in the corresponding CPDS subscriber contents database (612) and transmits data such as the initial menu and image, motion pictures, items indicated by the called party (200) etc. to the calling party (100). The CPDS contents processing part (622) allows the called party's wireless terminal (200) or PC (300) that are connected to the CPDS providing system (600) via Internet (500) to easily register/change the CPDS initial menu and contents. In other words, the menu and contents requested from the called subscriber wireless terminal (200) or PC (300) are provided by the CPDS subscriber contents database (612) and the CPDS general contents database (613) such that the CPDS initial menu and contents is able to be easily configured. The CPDS subscriber processing part (623) accesses and authenticates the called party's wireless terminal (200) or PC (300) subscribers that are connected to the CPDS providing system (600) via Internet (500), for the purpose of registering/changing the CPDS initial menu.

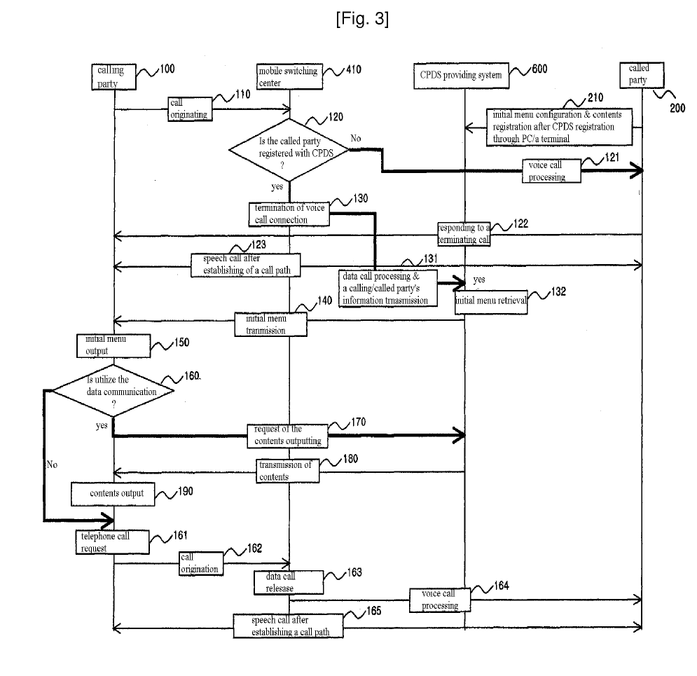

FIG. 3 illustrates a flow chart showing the general service flow on which the calling subscriber uses the CPDS according to the present invention.

When the calling wireless terminal (100) attempting a call origination (sending a call) (110), MSC (410) confirms whether or not the terminating (called party) subscriber is registered with the CPDS (120). If the termination subscriber is not registered with the CPDS, the MSC (410) performs the voice call processing (121) and then, if the termination subscriber responds (122), establishes a call path and allows for the performance of a speech call (123). If the termination subscriber is registered with the CPDS, the MSC (410) is connected to the CPDS providing system by terminating the connection of the voice call and changing it to a data call, and the MSC (410) requests the initial menu which is registered by the CPDS termination subscriber by transmitting the information of the calling and the called party to the CPDS providing system. The CPDS providing system retrieves and finds (132) the types of CPDS initial menu which are classified according to the types of calling party and is registered by the calling party according to the CPDS initial menu and contents registration (210) procedure using the information of the calling and called parties and transmits (140) it to the terminal of the calling party. The calling wireless terminal (100) receives and transmits it to the calling party (140). If any calling party does not desire to the CPDS even though the called subscriber is registered with the CPDS, it is possible to request a speech call either by presetting the calling party's wireless terminal (100) whether or not he or she uses the CPDS or by transmitting it by keying together with the particular code (* or # key) before or after the called subscriber number.

When the calling party desires additional use of the contents corresponding to the CPDS initial menu output to the calling party's wireless terminal (100) after he or she retrieves the output CPDS initial menu, the calling party decides (160) whether or not he or she will use it at all times. When the outputting of the corresponding contents to the CPDS providing system is requested (170) by selecting the use of the data communication, the CPDS providing system (600) receives and transmits said requested outputting to the wireless terminal (100). The calling party's wireless terminal (100) receives the contents and provides (190) it to the calling party by outputting/reproducing them. Further, the calling party is able to perform the telephone call request any time during using the CPDS contents either by selecting the voice call request menu which is output in the CPDS contents output screen or by keying certain keys on the wireless terminal. At the time of requesting said telephone communication, the speech call (165) is performed through the procedure of call origination (162), data call release (163), voice call processing (164) and call path establishment.

While the present embodiment covers only a case in which the called subscriber is a wireless subscriber, it is possible to provide the menu and contents that are registered with a PC by the called subscriber to the calling party who is a wireless subscriber via Internet in the same manner as in the present invention, by associating the CPDS providing system with the wired switching network, even if the called party is not a wireless subscriber but a wired subscriber.

FIG. 4 is a flow chart showing the service flow on which the calling subscriber uses the CPDS in the aspect of call processing of the mobile switching center according to the present invention.

When the wireless terminal of a calling party (S100) performs a call origination (sends a call) (S110), the mobile switching center receives the request of call connection from the calling party and queries the information on the called subscriber. In order to query the information on the called subscriber, the HLR system of the mobile communication company is used and in this case the CPDS registration information is preferred to be stored in the HLR together with information on the called subscriber. The confirmation of whether or not it is registered with the CPDS and activated is performed together during the query of the information on the called subscriber. If it has not been registered, the common voice call processes (S121˜S124) are performed and the speech call (S215) is made. However, if the called subscriber is registered with the CPDS, the MSC terminates the voice call connection (S130), changes it to a data call process, transmits the information of the calling party and called party to the CPDS providing system and requests the CPDS providing system (S140) to provide the initial menu of the called subscriber. The CPDS providing system which has received the information of the calling and called party transmits the corresponding calling party's initial menu from the initial menus that are classified according to the types of calling party (family/school/company/fiance/friends/religion, etc.) to the wireless terminal (S100) using the received information on the calling and called party. The calling party's wireless terminal (S100) receives and outputs the corresponding menu and the calling party retrieves (S150) the initial menu registered by the called party and then when he or she desires to use the retrieved menu additionally, he or she is able to use/view/store (S160) the contents corresponding to the selected menu by responding to whether or not he or she uses data communication. By making it possible to request the speech call at any time according to the selection of the calling party even while the contents are used, the calling party release the existing data call (S180) and performs the voice call process (S121˜S124) to be able to perform the speech call (S215) with the called subscriber.

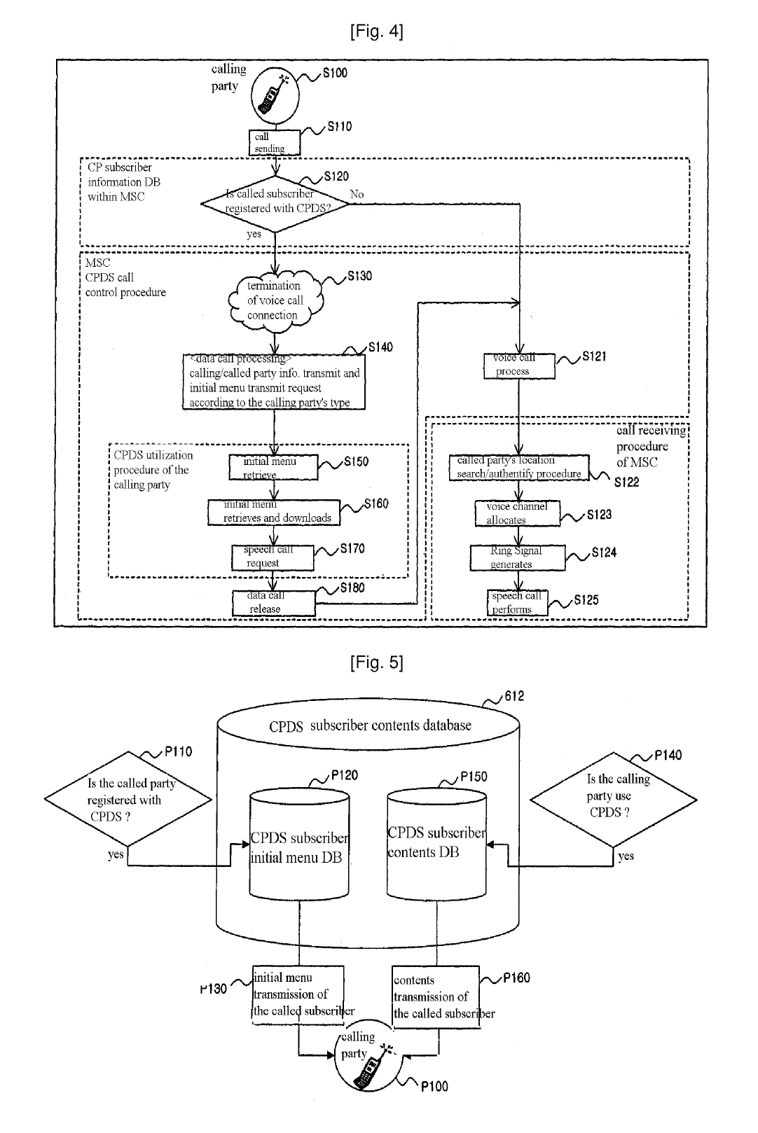

FIG. 5 shows a configuration of the CPDS subscriber contents database of FIG. 2 in conjunction with the process of data transmission.

When the calling party requests the call origination, the CPDS subscriber initial menu database (P120) retrieves the called subscriber's initial menu which conforms to the corresponding calling party according to whether or not the called party is registered, and the selected initial menu is transmitted (P130) to the calling party's terminal (P100). The initial menu of the called subscriber can be implemented together with background/motion picture/image/music/text, and the initial menu is a list in which the contents desired to be shown to the calling party by the called party are grouped.

When the calling party desires to use additionally the contents grouped in the corresponding menu by retrieving the initial menu of the called subscriber and selecting any menu of the initial menus, the message window inquiring about whether or not he/she wishes to use the CPDS data communication is output on the calling party's terminal (P100). If said calling party responds to the use of CPDS data communication, the corresponding contents retrieved from the CPDS subscriber contents database (P150) are transmitted (P160) to the calling party's terminal (P100) and output on the calling party's terminal (P100). Accordingly, the calling party can use the various image/character/motion picture/screen/items that are possessed by the called subscriber.

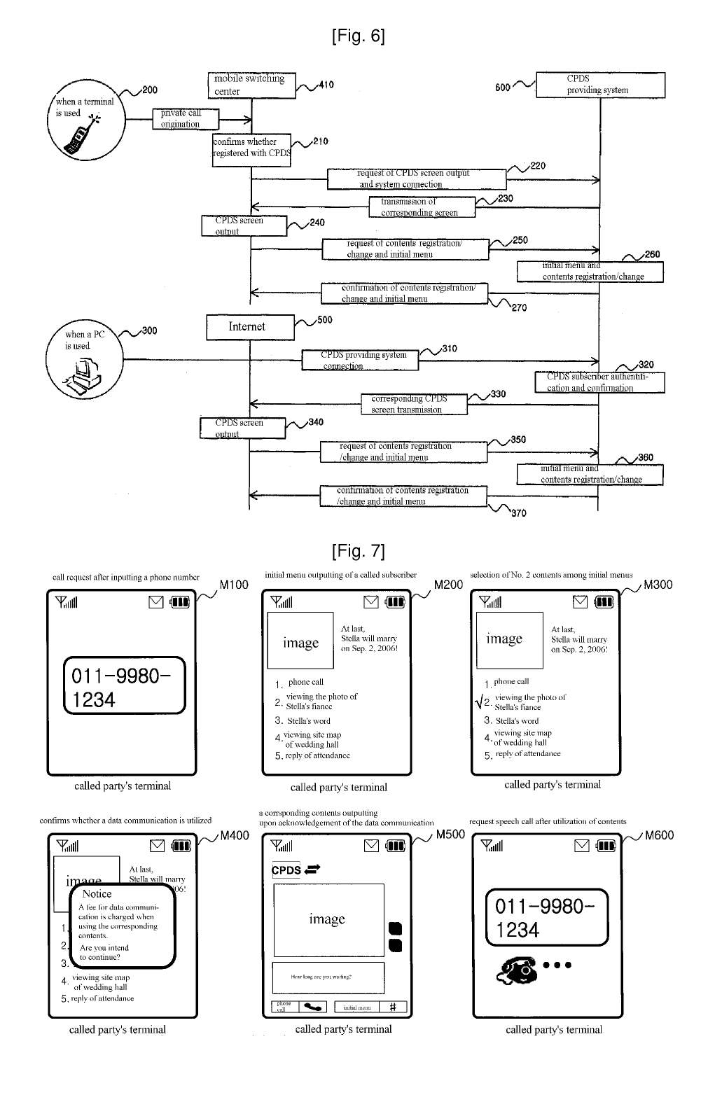

FIG. 6 shows an embodiment of the methods by which the called subscriber registers or changes the CPDS screen and contents according to the present invention.

The called subscriber performs the request of connection to the CPDS providing system (600) using the private call origination method via the called mobile terminal (200). When it is intended to register/change the CPDS through the private call origination, it is preferable to separately install/operate the CPDS self-call controller within the mobile switching center. The CPDS self-call controller confirms whether the called number is identical with the mobile identification number (MIN) when the called subscriber sends (originates) a call having his or her terminal number using his or her wireless terminal (200). When it is determined, during the authentification process, that the called number is identical with the mobile identification number, the CPDS private call controller serves a request to confirm whether the CPDS of the calling party is registered in the Home Location Register (HLR) of the mobile communication company. The mobile switching center (410) confirms (210) the corresponding subscriber and then requests either output of the CPDS registration initial screen or the CPDS initial menu registered by the called subscriber according to whether he or she is subscribed with the CPDS. The CPDS providing system (600) transmits (230) the corresponding CPDS screen to the called wireless terminal according to whether he or she is subscribed with the CPDS and the called wireless terminal outputs the received CPDS screen. The called subscriber is able to produce and change the CPDS initial menu and contents with the called wireless terminal (200) through the functions provided by the CPDS providing system (600). When the called subscriber requests (250) registration or change of the CPDS initial menu and contents through said functions provided by the CPDS providing system (600), the CPDS providing system (600) accordingly allows for the corresponding subscriber to register or change his or her CPDS initial menu and contents. The CPDS providing system (600) informs the called subscriber that the procedures for registration/change have been completed normally through confirmation (270) of whether the initial menu and contents is registered/changed with the called party's terminal (200).

A PC via the Internet is also able to connect with the CPDS providing system (600). This process is useful to the called subscriber who uses a conventional wired telephone which is not a wireless terminal (200) to register and change the CPDS initial menu and contents.

A PC (300) is connected (310) to the CPDS providing system through the internet home page, and the CPDS providing system permits connection through the authentification/identification process (320) of the corresponding subscriber and transmits (330) the CPDS screen of corresponding subscriber to the PC. The called subscriber confirms the registration initial screen output to the PC and the CPDS initial screen registered by the called subscriber, and then requests (350) the registration/change of the CPDS initial menu and contents through the functions provided by the CPDS providing system (600) and accordingly the CPDS providing system (600) informs (370) the called subscriber of whether or not the CPDS initial menu and contents are registered or changed after performing the registration or change of the CPDS initial menu and contents.

FIG. 7 shows an embodiment of service flowchart on which a calling party uses the CPDS service registered by a called subscriber according to the present invention.

When the calling party requests (M100) a communication by inputting the telephone number (011-9980-1234) of the called party and pressing the call key for the telephone communication, the CPDS initial menu of the called subscriber is output (M200) on the terminal (100) of the calling party. Said initial menu is one of the plurality of menus that are classified by the called subscriber according to the type of calling party upon the registration of the CPDS service, and in FIG. 7, it is drawn up on the assumption that it is the CPDS initial menu for a group of friends. If said initial menu is output on the calling party's terminal (100), the calling party is able to use the contents corresponding to the selected menu by selecting a menu among various menus. When the calling party requests the corresponding contents by selecting (M300) No. 2 menu of the initial menu, the calling party is notified (M400) by pop up message window that a fee for data communication will be charged. When he or she responds to it, the corresponding contents is output (M500) on the calling party's terminal (100). It is also possible to use additionally the contents contained in other menu by retrieving the various photos using the control key placed in the screen and then moving to the initial menu screen using the # key. According to the method described above, the calling party is able to request (M600) a speech call with the called party by pressing the call key after retrieving or downloading various contents.

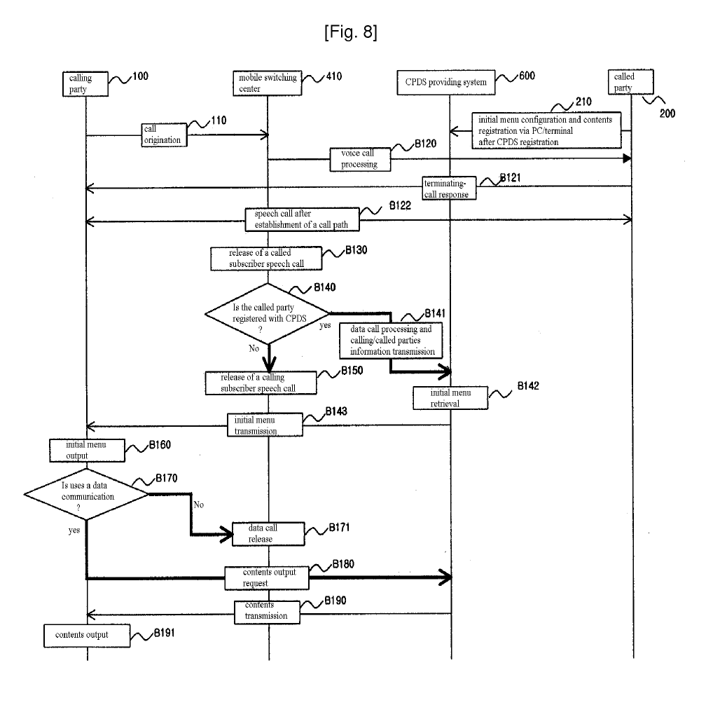

FIG. 8 shows another form of service flowchart on which any calling party uses the CPDS service of the called subscriber according to the present invention. This figure explains the method of using the CPDS initial menu and contents that is registered by the called subscriber after the calling party performs the speech call. This figure is different from FIG. 3 in that the process confirming whether or not the CPDS registration of the called party is done at the time of the speech call being completed.

If the calling party's terminal (100) originates a call (110), the MSC (410) performs the voice call process (B120) and performs the speech call (B122) after establishing the call path through the call termination response (B121) of the called (terminating) subscriber s terminal (200). If the called party releases (B130) the voice call path after performing the speech call, the MSC (410) confirms whether or not the called subscriber is registered (B140) with the CPDS, and if the called subscriber is not registered, the MSC (410) releases (B130) the voice call path of the calling party. If the called subscriber is registered, the MSC (410) change the voice call to a data call process and connects it to the CPDS providing system, and transmits (B141) the information of the calling party and called parties and requests the initial menu registered by the CPDS called subscriber. The CPDS providing system retrieves and searches (B142) the CPDS initial menu using information on calling and called parties by registered calling parties that is registered by the called party according to the CPDS initial menu and contents registration (210) procedure and then transmits (B143) it to the calling party's wireless terminal (100). The calling party's wireless terminal (100) receives and outputs (B160) it to the calling party.

When the calling party retrieves the CPDS initial menu output on his or her wireless terminal (100) and desires to use further the contents corresponding to said menu, the calling party decides (B170) whether or not he or she wishes to use data communication. If the calling party selects to utilize data communication and requests (B180), the CPDS providing system to output the corresponding contents, the CPDS providing system receives said request and transmits (B190) the corresponding contents to the calling party's wireless terminal (100). Then, the calling party's wireless terminal (100) receives and provides the contents to the calling party by outputting/reproducing it. When the calling party does not desire to use the contents corresponding to said menu, the MSC (410) releases (B171) the data call by indicating that he or she does not desire to use data communication during the confirmation process (B170).

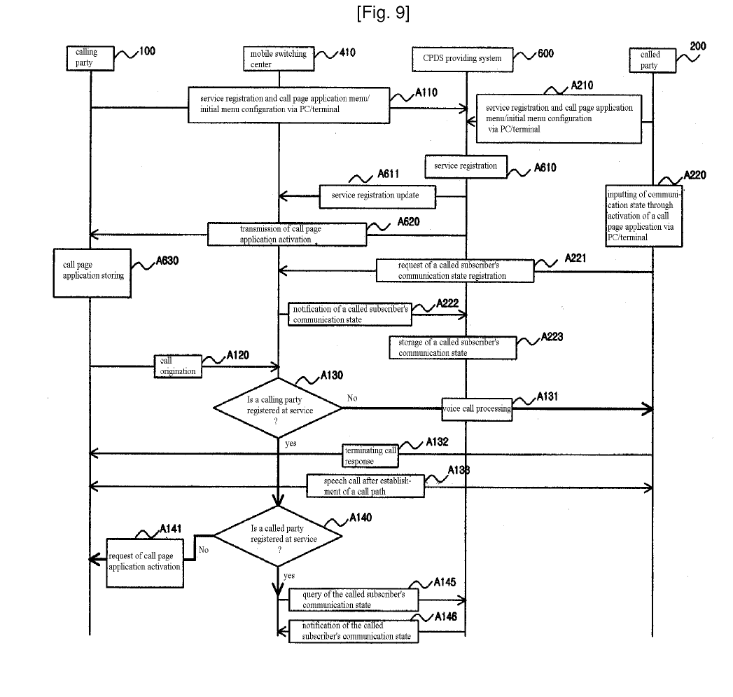

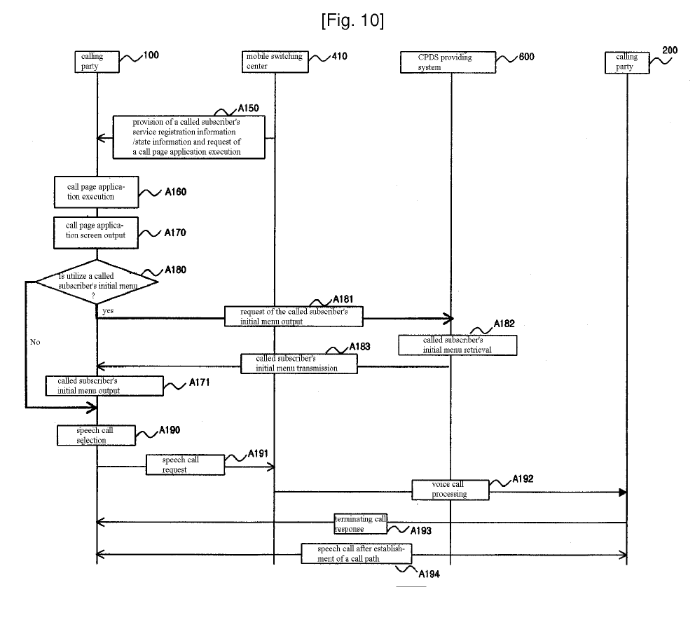

FIGS. 9 and 10 shows an embodiment of a service flowchart on which the calling party uses the CPDS service of the called subscriber using the Call Page Application according to the present invention.

These figures show another embodiment of the present invention which, according to the invention, is able to prevent beforehand the complaints that can occur in cases where a calling party, who does not desire to use the service, reluctantly uses said service by performing the procedure confirming whether or not the calling party is registered with the CPDS prior to performing the procedure confirming whether or not the called party is registered with the CPDS. In addition, it is possible to identify the communicable status of the called subscriber on the screen of the application that is provided by the execution of the application program of the calling party's terminal by selecting the functions of speech call and SMS, from the initial menu access of called subscriber. The method of executing said calling party's terminal application allows for the calling subscriber to selectively retrieve the initial menu of the called subscriber, and thus does not need to wait for the outputting of the initial menu of the called subscriber when the calling subscriber originates a call for performing a speech call, thereby incrementing the convenience of the calling subscriber.

If the calling party (100) or called party (200) requests the service registration via his or her terminal, the MSC (410) allows for the calling (100) or called party (200) to connect a call to the CPDS providing system (600) and accordingly the calling party (100) comes to configure the menu of the call page application screen or initial menu at his or her desire. Upon completion of such configuration, the CPDS performs the service registration (A610), and then informs the result of it to the MSC (410), followed by notification (A611) that the corresponding subscriber has completed the CPDS service registration. And the CPDS providing system (600) transmits (A620) to the calling (originating) subscriber (100) the call page application which is configured (selected) by the calling subscriber, and the calling subscriber (100) stores it in the wireless terminal, thereby completing (A630) readiness for CPDS use. Said application storing procedure applies similarly to the called subscriber (200) who has subscribed to CPDS service. Said application is a sort of an application program for mobile terminals to support the service by the types of menu such as initial menu connection or speech call requests, etc., provided by the called subscriber and is possible to be implemented on the terminal which supports the WIPI (Wireless Internet Platform for Interoperability) platform.

The called subscriber (200) is able to input (A220) his or her communicable state in the supervisor mode of the application by executing the application which is stored through the CPDS service subscribing stage (A210). The communication state information inputted by the called subscriber (200) requests MSC (410) to effect his or her registration via the application of the called subscriber terminal and the MSC (410) notifies (A222) the communication state information to the CPDS providing system (600) and stores (A223) it thereby completing the procedure of communication state registration.

If the calling party (100) originates a call (A120), the MSC (410) confirms (A130) whether or not the calling party is registered with the CPDS. If the calling party is not registered, the MSC performs the voice call process (A131) and if the called party responds (A132), the speech call can be made (A133) after establishing the call path. If the calling party has been registered with the CPDS, the MSC (410) confirms (A140) whether or not the called subscriber is registered with the CPDS service. If the called party has not been registered with the CPDS service, the MSC requests (A141) the calling party (100) to execute the call page application which does not include the initial menu of the called party. If the called party has been registered with the CPDS service, the MSC requests (A150) the calling party (100) the execution of the call page application which includes the state information of the called subscriber and the service registration information through the state query and the notification processes (A145 and A146) of the called subscriber. During the process of said call page application execution request procedure, the state information of the called party (line is busy, Power Off, non-registration of the service) included in the HLR of the MSC (410) can be provided together with the communication state information which has been registered by the called party (200). The wireless terminal of the calling party (100) executes the call page application which was already stored through the registration of the CPDS service if the wireless terminal receives the request of the call page execution from the MSC (410). The calling party (100) may adjust the outputting time of the application screen according to the event which is preset through the screen output option function provided from the call page application. For example, when the calling party (100) sets the event that the call page application screen output is executed in a case where communication with the called party (200) is impossible. The call page application screen is output only when the called party (200) is not able to communicate. If the called party (200) is in communicable state, the calling party is able to communicate with the called party (200) immediately without outputting the call page application screen and is able to output the call page application screen upon terminating the speech call. The incommunicable states of the called party during the determination process of the communication state of the called party includes cases in which the called party is on the telephone, the electric power of the terminal is in cut off state, or the state is set as incommunicable by the called party. If the calling party (100) always desires to output the call page application screen, the call page application screen is output (A170) as shown in this figure independent of the communication state of the called party through said application execution (A160) procedure and the calling subscriber confirms whether or not the communication is possible and the initial menu of the called subscriber is registered.

Thereafter, the calling party (100) accesses SMS, MMS and the initial menu of the called party using the menu output on the call page application screen. This figure shows an embodiment in which the calling party (100) utilizes the mobile contents by selecting the initial menu of the called subscriber or performs the speech call by selecting it. If the calling party (100) selects (A180) the initial menu of the called subscriber, the MSC (410) requests the CPDS providing system (600) to provide with the initial menu of the called subscriber (A 181) upon receiving the selected initial menu of the called subscriber and transmits it together with the information of the calling/called party, and the CPDS providing system (600) retrieves (A182) the corresponding initial menu of the called subscriber and transmits (A183) it to the calling party (100). If the calling party (100) selects (A190) speech call, the MSC (410) receives it and performs (A192) the speech call (call) process and performs (A193) the speech call through the called (terminating) party response (A193) and the establishment of a call path.

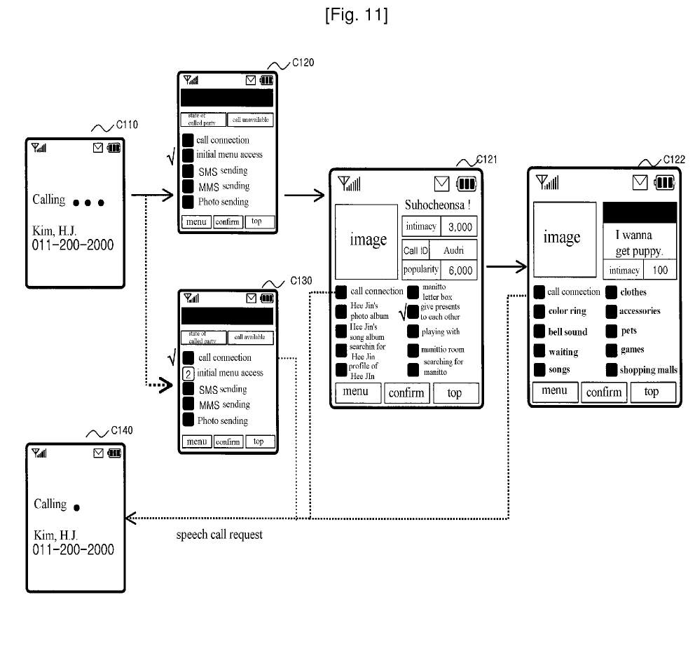

FIG. 11 shows a service flowchart illustrated in FIGS. 9 and 10 in the aspect of the calling party subscribers to utilize the CPDS service.

When the calling subscriber (100) requests (C110) a communication after inputting the telephone number (011-200-2000) for a telephone communication, the call page application screen, which has been configured by him or her, is output on the terminal of the calling subscriber (100). At this time, if the called party (200) has registered with the CPDS service and has his or her initial menu screen, the initial menu of the called party (“the initial menu access” item on the screen) is activated and the screen is output (C120). If the called party (200) has not been registered with the CPDS service, a screen in which the initial menu of the called party (“the initial menu access” item on the screen) has not been activated is output (C130). Said call page application screen is a screen which is configured, when the calling subscriber (100) registers with the CPDS service, in a manner that the selected functions used frequently by the calling subscriber (100) are included. When said screen is configured, the speech call key and the initial menu access key is provided basically, and the functions of SMS, MMS and the photo sending, etc., can be selectively provided by the choice of calling subscriber. Said functions such as SMS, MMS and the photo sending may be contents or services that are accessed and used by wireless Internet and also may be contents or services that are provided directly from the mobile switching network without being connected to the mobile Internet. When the calling subscriber (100) requests “the initial menu access” in step C120, the initial menu screen that is provided by the called subscriber (200) is output (C121). The calling subscriber (100) is able to utilize (C122) the output contents that are output by the request of output of specified contents after retrieving the various information and contents provided by the called subscriber (200). During the utilization of said screens, the calling subscriber (100) may request a speech call, and the speech call request screen is output (C140) by pressing the communication connection key, and the procedure of the voice call processing (A192-A194) illustrated in FIG. 10 is initiated.

### INDUSTRIAL APPLICABILITY

All of the mobile communication subscribers are able to serve as a CP (Contents Provider) who configures his or her contents through such a data service system and provides any calling party with the contents, and also any of the calling parties use data services provided by a called party naturally with interests, so that it is possible to contribute to revitalization of data communication by growing out of the current telephone communication scheme which is principally oriented toward speech calls. Further, it is possible to be extended unlimitedly to a major provides of 3^{rd} generation (WCDMA) or 3.5^{th} generation (HSDPA) mobile communication services which claim to offer high data transfer rates.

In addition, the problem of shortage of contents due to a limited channel of distribution can be solved thanks to the present invention, thereby motivating all users (including private user or business user) who utilize the service of the present invention to develop their own contents. Further, it is possible to contribute to a leap towards a powerful mobile nation that is matched well with a nation powerful in mobile terminal and mobile communication.

1. A data communication system for performing a data communication through call separation and control by a mobile switching center in a mobile communication network which uses a mobile terminal, the data communication system comprising:
CPDS providing system connected to said mobile communication network which comprises a database which is accessed through wired or wireless communication means so that the information and contents of a user can be registered, and a contents provider data service (CPDS) control unit which controls said information and contents of a database according to the request of the calling or called parties so that said information and contents are transmitted to the wireless terminal of the calling or called parties; and mobile switching center which comprises a call separation and control which, when a call is originated from the wireless terminal of the calling party or a call path is released from the called party after performing a speech call, terminates the voice call connection and changes it to a data call so that said wireless terminal of the calling party is connected to the CPDS providing system according to the result of whether the called party is registered with said CPDS providing system, and which changes the data call to a voice call or releases the call according to the request of the calling party.

2. A data communication method for performing a data communication through the call separation and control of a mobile switching center in a mobile communication network which uses a mobile terminal, the data communication method comprising the steps of:
determining through the mobile switching center, whether the called party is registered with the CPDS connected to said mobile communication network when a call is originated from the wireless terminal of the calling party;
establishing the call path by the response of said called party by performing the voice call process if said called party is not registered with said CPDS as its user according to the result of said determination on whether or not the called party is registered;
terminating the voice call connection and changing it to a data call, and connecting the wireless terminal of the calling party to said CPDS providing system if said called party is registered with said CPDS as its user according to the result of said determination of said registration of the called party;
a first data service transmitting for transmitting the initial menu of the called party stored in the CPDS providing system to the wireless terminal of the calling party when the wireless terminal of the calling party is connected to the CPDS providing system;
confirming whether or not the calling patty will use the data communication when the calling party selects a menu among said initial menus and requests the contents corresponding to the selected menu;
a second data service transmitting for transmitting said requested contents to the wireless terminal of the called party when the calling party confirms that he or she will use the data communication; and establishing the call path between the calling and called parties by releasing the data call and performing the voice call process according to the speech call request of the calling party.

3. The method according to claim 2, further comprising the steps of:
connecting said CPDS user to the CPDS providing system via a wireless terminal or Internet; and registering the initial menu and contents with the database within said CPDS providing system and changing said initial menu and contents by configuring the initial menu and contents by said CPDS user.

4. The method according to claim 3, wherein said initial menu and contents are stored separately in their respective databases when said initial menu and contents are registered in said database of said CPDS providing system, and wherein said initial menu and contents are managed by associating each initial menu with the corresponding contents.

5. The method according to claim 3, wherein said CPDS user accesses said CPDS providing system using a private call originating scheme when said CPDS user accesses said CPDS providing system through the wireless terminal.

6. The method according to claim 3, said step of configuring the initial menu and contents comprising the step of classifying the calling parties into a predetermined type and configuring each initial menu and contents corresponding to said respective classified type of calling patty.

7. The method according to claim 6, said step of a first data service transmitting for transmitting the initial menu which corresponds to the classified type to which said calling party belongs among said initial menus to the wireless terminal of said calling party, wherein said initial menus are classified into types of calling party.

8. A data communication method for performing a data communication through call separation and control by a mobile switching center in a mobile communication network which uses a mobile terminal, the data communication method comprising the steps of:
determining by the mobile switching center, whether the called party is registered as a user of the CPDS connected to said mobile communication network when a call path is released from the called party;
releasing the call path of the called party if said called party is not registered with said CPDS as its user according to the result of the determination as to whether its called party has been registered;
changing said call path to a data call, and connecting the wireless terminal of the calling party to said CPDS providing system if said called party is registered with said CPDS as its user according to the result of the determination as to whether its called party has been registered;
a first data service transmitting for transmitting an initial menu of the called party stored in the CPDS providing system to the wireless terminal of the calling party when the wireless terminal of the calling party is connected to the CPDS providing system;
confirming whether or not the calling party will use the data communication when the calling party selects a menu among said initial menus and requests the contents corresponding to the selected menu;
a second data service transmitting for transmitting said requested contents to the wireless terminal of the called party when the calling party confirms that he or she will use the data communication; and releasing the data call at the request of the calling party.

9. A data communication method for performing a data communication through call separation and control by a mobile switching center in a mobile communication network which uses a mobile terminal, the data communication method comprising the steps of:
configuring the CPDS service registration and call page application menu through PC or wireless terminal by the calling party and storing said call page application menu in his or her wireless terminal;
inputting the information relating to the called patty's communicable state through the call page application execution by the called patty and storing said information in the CPDS providing system;
confirming by the mobile switching center whether the calling or called parties have been registered with CPDS and requesting the calling party to execute the call page application when the calling patty attempts a voice call;
outputting the call page application screen according to the application screen output option which is preset by the calling party when said call page application is executed on the wireless terminal of the calling party;
processing having the speech call keep going on, having SMS, MMS, etc., being used, or having the initial menu provided by the called party being utilized according to the selection of the calling party after confirming the state of the called party whether or not the service registration has been registered, when said call page application screen is output on the wireless terminal of the calling party; and
releasing the data call according to the request of the calling party.
